(19) United States
(12) Patent Application Publication
(10) Pub. No.: US 2026/0220264 A1
(43) Pub. Date: Jul. 30, 2026

(54) MALWARE DETECTION METHOD AND RELATED APPARATUS

(71) Applicant: Huawei Technologies Co., Ltd., Shenzhen (CN)

(72) Inventors: Yang Zhou, Thornhill (CA); Ronnie Salvador Giagone, Surrey (CA); Sheng qiang Huang, Vancouver (CA)

(21) Appl. No.: 19/038,391

(22) Filed: Jan. 27, 2025

(51) Int. Cl. G06F 21/56

(52) U.S. Cl. CPC G06F 21/565; G06F 21/564

(57) ABSTRACT

Provided are a malware detection method and related apparatus. In the method, a dump file is obtained from a packed file, and then analysis and detection can be performed on the dump file to determine whether the dump file includes malware. The malware detection is based on analysis and detection for the dump file. In this way, the malware detection accuracy can be improved compared with static analysis detection, and the malware detection efficiency can be improved compared with pure dynamic analysis detection (e.g., running the packed file).

### TECHNICAL FIELD

The present disclosure relates to the field of technologies of information security, and in particular, to a malware detection method and related apparatus.

### BACKGROUND

Malware refers to malicious software that is designed to cause damage to computer systems, the network or personal devices, etc. And malware detection is important for information security, which may refer to a process of identifying and analyzing malware. With the development of related technologies, shelling techniques are commonly used, that is, the malware may be in form of a packed file.

Packed malware detection refers to a process of identifying and analyzing malicious software that has been compressed or encrypted using specialized techniques known as packers. The use of packers allows malware to modify its binary structure, making it more difficult for the antivirus software and other security tools to recognize and analyze its malicious behavior.

This background information is provided to reveal information believed by the applicant to be of possible relevance to the present disclosure. No admission is necessarily intended, nor should be construed, that any of the preceding information constitutes prior art against the present disclosure.

### SUMMARY

According to a first aspect, an embodiment of the present disclosure provides a malware detection method, including:
obtaining a first file from a second file, where the second file is a packed file of an original file, and the first file is a dump file obtained through unpacking the second file; and
determining, based on information of the first file, whether the first file includes a malware.

In the solution, the second file corresponds to software which is intended to be detected, while the first file refers to a dump file corresponding to the software. Analysis and detection can be performed based on information of the first file to determine whether the first file includes malware. The first file is a dump file that is obtained through unpacking the packed file (the second file), e.g., by using an emulator, and the first file has information consistent/aligned with the original file. That is, the malware detection is based on analysis and detection for a dump file, and, the determination result of whether the dump file includes malware can indicate whether the packed file includes malware. In this way, the malware detection accuracy can be improved compared with static analysis detection, and the malware detection efficiency can be improved compared with pure dynamic analysis detection (e.g., running the packed file).

In a possible implementation, the method further includes: determining that the second file includes a malware when it is determined that the first file includes a malware; and determining that the second file does not include a malware when it is determined that the first file does not include a malware.

The determination result of whether the first file (i.e., the dump file) includes malware can indicate whether the second file (i.e., the packed file) includes malware. When the first file includes malware, it can be determined that the second file includes malware; when the first file does not include malware, it can be determined that the second file does not include malware. The malware detection for a packed file is implemented through the malware detection for a dump file. The malware detection can be accurate and safe with competent speed.

In a possible implementation, the determining whether the first file includes a malware includes: inputting the information of the first file into a pre-trained model, where the pre-trained model is used for detecting a malware and the information of the first file includes at least a portion of the first file; and determining whether the first file includes a malware based on an output of the pre-trained model.

A pre-trained model can be used for detecting a malware in the first file. All or part of the first file may be inputted into the pre-trained model for malware detection. For example, the information inputted into the pre-trained model can include all bytes of the first file, or include a code section of the first file or some bytes of the code section, etc. The information inputted into the pre-trained model can be selected according to actual requirements. The determination result of whether the first file (the dump file) includes malware can be obtained through the pre-trained model, and the generalization power of the pre-trained model can be utilized to improve the malware detection efficiency.

In a possible implementation, the portion of the first file includes a first portion of the first file, where content of the first portion of the first file is identical to content of a second portion of the original file.

The first portion of the first file can be a part of the first file which has identical content (e.g., bytes) to a corresponding part (i.e., the second portion) of the original file. The first portion and the second portion may be some ranges of bytes in the first file and the second file respectively. For example, the first portion can be a range of bytes of the code section of the first file while the second portion can be a corresponding range of bytes of the code section of the original file. The dump file can have information consistent/aligned with the original file, and the content of the first portion of the first file can be identical to the content of the second portion of the original file. The malware detection for the packed file is based on the malware detection for the dump file, hence, the malware detection accuracy can be ensured.

In a possible implementation, the first portion of the first file includes a first range of bytes nearby an entry point of the first file, and the method further includes obtaining the entry point of the first file, where the entry point of the first file is consistent with an entry point of the original file.

The entry point of the first file refers to a specific location in the code associated with the first file where the program starts execution. The entry point of the first file is consistent with the entry point of the original file, and thus the entry point of the first file can serve as an anchor point to select bytes for malware detection, which can ensure malware detection accuracy.

In a possible implementation, the first range of bytes nearby the entry point includes a first number of bytes before the entry point and a second number of bytes after the entry point.

The first portion can include some bytes before the entry point of the first file and some bytes after the entry point of the first file. The specific numbers of bytes before and after the entry points contained in the first portion can be determined according to actual requirement, which provides more flexibility for the malware detection.

In a possible implementation, the inputting the information of the first file into the pre-trained model includes: inputting the first portion of the first file into the pre-trained model.

By inputting the first portion of the first file into the pre-trained model, the information inputted into the model can be narrowed down, and the amount of data to be processed by the model can be reduced, thereby increasing the speed of malware detection while ensuring detection accuracy.

In a possible implementation, the inputting the information of the first file into the pre-trained model includes: obtaining integer numbers based on the information of the first file; scaling the integer numbers to obtain scaled values; and inputting the scaled values into the pre-trained model.

By scaling the integer numbers obtained from the information of the first file, inputs can be standardized to a specified range, which can improve the accuracy of the model since the model can achieve better performance at similar scales.

In a possible implementation, the method further includes: obtaining training samples, where each of the training samples is a file that has not been packed or encrypted, or a portion of a file that has not been packed or encrypted, and one or more samples of the training samples include a malware; and training a model with the training samples to obtain the pre-trained model.

Each of the training samples is a file that has not been packed or encrypted, or a portion of such a file, it means that the pre-trained model can be trained with general samples, other than packed files or unpacked files obtained through unpacking packed files. Although the model is trained with general sample, the model can be used for malware detection on the dump file, or for malware detection on the packed file through malware detection on the dump file, since the dump file has information consistent/aligned with the original file. Training a model with general samples would be easy to maintain and implement. In addition, it is not required to prepare a large amount of unpacked data for various types and versions of packers compared with traditional model training.

In a possible implementation, the pre-trained model includes at least one of: a convolutional neural network (CNN) model, a recursive neural network (RNN) model, a long short-term memory (LSTM) model, or a transformer model.

The model can adopt various types of sequence models which can learn and extract features from sequences. A specific type of model can be selected according to actual requirements.

In a possible implementation, the determining, based on the information of the first file, whether the first file include a malware includes: generating a signature of the first file based on a third portion of the first file, where the information of the first file includes the third portion of the first file, and the third portion of the first file includes a second range of bytes nearby an entry point of the first file; and determining whether the first file includes a malware based on a comparison of the signature of the first file and signatures of malwares.

Signature-based detection can be used to determine whether the first file includes malware. The signature can be generated based on part of the first file, and then compared with signatures of know malwares to determine whether the first file include a malware. The signature-based malware detection for the dump file can be easily implemented, on this basis, thereby providing a simple but effective way for the malware detection for the packed file. This detection method can be employed, e.g., when no trained model is available, for example, when the model has not been well-trained, e.g., due to insufficient training data.

In a possible implementation, the signature of the first file is generated based on statistical information of the third portion of the first file or hashing of the third portion of the first file.

According to a second aspect, a malware detection apparatus is provided by an embodiment of the present disclosure, and the malware detection apparatus has a function of implementing the first aspect. For example, the malware detection apparatus includes a corresponding module, unit or means for performing operations in the first aspect. The module, unit or means maybe specifically implemented by using software, may be implemented by using hardware, or may be implemented by using software in combination with hardware.

According to a third aspect, another malware detection apparatus is provided by an embodiment of the present disclosure. The malware detection apparatus includes one or more processors. A memory is configured to store a part or all of a necessary computer program or instructions for implementing a function in the first aspect. The one or more processors may execute the computer program or the instructions, and when the computer program or the instructions is/are executed, the malware detection apparatus is enabled to implement the method in any possible implementation or implementation of the first aspect.

In a possible implementation, the malware detection apparatus may further include an interface circuit, and the processor is configured to communicate with another apparatus or component through the interface circuit.

In a possible implementation, the apparatus may further include the memory.

According to a fourth aspect, an embodiment of the present disclosure provides a computing device cluster including at least one computing device, and the computing device includes at least one processor and a memory coupled with the processor, where the memory stores instructions which, when executed by the at least one processor, cause the computing device cluster to execute the method in any one of the possible implementations of the first aspect.

According to a fifth aspect, an embodiment of the present disclosure provides a non-transitory computer-readable storage medium. The non-transitory computer-readable storage medium stores computer-readable instructions, and when a computer reads and executes the computer-readable instructions, the computer is enabled to perform the method in any one of the possible implementations of the first aspect.

According to a sixth aspect, an embodiment of the present disclosure provides a computer program product. When a computer reads and executes the computer program product, the computer is enabled to perform the method in any one of the possible implementations of the first aspect.

According to a seventh aspect, an embodiment of the present disclosure provides a computer program. When a computer reads and executes the computer program, the computer is enabled to perform the method in any one of the possible implementations of the first aspect.

This application encompasses various embodiments, including not only method embodiments, but also other embodiments such as apparatus embodiments and embodiments related to non-transitory computer readable storage media. Embodiments may incorporate, individually or in combinations, the features disclosed herein.

A malware detection method and related apparatus are provided by the present disclosure. After unpacking the packed file, that is, after the first file is obtained, analysis and detection can be performed on the first file to determine whether the first file includes malware. The first file is a dump file, that is, the malware detection is based on analysis and detection for the dump file. Further, the determination result of whether the dump file includes malware can indicate whether the packed file includes malware. In this way, the malware detection accuracy can be improved compared with static analysis detection, and the malware detection efficiency can be improved compared with pure dynamic analysis detection (e.g., running the packed file).

### BRIEF DESCRIPTION OF THE DRAWINGS

The accompanying drawings are used to provide a further understanding of the present disclosure, constitute a part of the specification, and are used to explain the present disclosure together with the following specific embodiments, but should not be construed as limiting the present disclosure.

FIG. 1 is a schematic illustration of a security architecture for a device to detect malware according to one or more embodiments of the present disclosure.

FIG. 2 is a schematic illustration of the appliance of the malware detection solution according to one or more embodiments of the present disclosure.

FIG. 3 is a schematic illustration of the processing of a portable executable (PE) file according to one or more embodiments of the present disclosure.

FIG. 4 is a flowchart of a malware detection method according to one or more embodiments of the present disclosure.

FIG. 5 is another flowchart of a malware detection method according to one or more embodiments of the present disclosure.

FIG. 6 is a schematic illustration of scaling the extracted sequence according to one or more embodiments of the present disclosure.

FIG. 7 is a schematic illustration of the malware detection process according to one or more embodiments of the present disclosure.

FIG. 8 is another schematic illustration of the malware detection process according to one or more embodiments of the present disclosure.

FIG. 9 is a schematic illustration of true positive rate and false positive rate for different malware detection methods and the malware detection method of the present disclosure.

FIG. 10 is still another schematic illustration of the malware detection process according to one or more embodiments of the present disclosure.

FIG. 11 is a block diagram of a malware detection apparatus according to one or more embodiments of the present disclosure.

FIG. 12 is a schematic structural diagram of a computing device according to one or more embodiments of the present disclosure.

FIG. 13 is a schematic diagram of an architecture of a computing device cluster according to one or more embodiments of the present disclosure.

FIG. 14 is a schematic diagram of a connection between computing devices over a network according to one or more embodiments of the present disclosure.

### DETAILED DESCRIPTION

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

Packed malware detection refers to the process of identifying and analyzing malicious software that has been compressed or encrypted using specialized techniques known as packers. These techniques are commonly used by malware authors to obfuscate their code and evade detection by traditional security mechanisms.

The use of packers allows malware to modify its binary structure, making it more difficult for the antivirus software and other security tools to recognize and analyze its malicious behavior. Packers can compress the malware code, encrypt the malware code, or both, making it harder for security solutions to identify and interpret the malicious instructions.

To detect packed malware, security researchers and antivirus vendors employ various techniques and technologies. These include static analysis, which involves examining the packed file without executing it, and dynamic analysis, which involves running the packed malware in a controlled environment to observe its behavior.

Static analysis techniques involve unpacking the malware to reveal its original code. This can be done by using specialized tools or by reverse engineering the packing algorithm. Once the malware is unpacked, it can be analyzed for malicious behavior and signatures can be generated to detect similar instances in the future. Static unpacking is advantageous as it is fast and safe, yet there are also some drawbacks. It may not work for unknown or custom packers that are not supported by existing tools or require complex analysis. Additionally, it may miss some hidden code or data that is only revealed during dynamic unpacking, and it may not preserve the original memory layout or imports of the malware, which could alter its behavior or analysis.

Dynamic analysis techniques involve executing the packed malware in a controlled environment, such as a virtual machine or sandbox, to observe its behavior. This allows researchers to monitor the malware's actions, such as file system modifications, network communications, and system-level changes. By analyzing the malware's behavior, security solutions can detect and block malicious activities. However, dynamic unpacking also has some drawbacks, such as being slow and risky due to running the malware and potentially exposing the system to infection or damage. Additionally, some malware that uses anti-debugging or anti-vm (anti-virtual machine) techniques may be difficult or impossible to analyze through dynamic unpacking. Moreover, it may require manual intervention or analysis to identify the correct moment and location of the unpacking.

In recent years, machine learning and artificial intelligence (AI) techniques have been increasingly used to enhance packed malware detection. These technologies enable security solutions to learn from large volumes of data and identify patterns indicative of malicious behavior. AI-based approaches can help improve the accuracy and speed of packed malware detection, enabling security solutions to keep up with the evolving threat landscape.

In short, the detection of packed malware is a significant challenge in the security field. Due to the inability to fast extract accurate content information, analysts and engineers find it extremely difficult to detect and analyze packed files. Additionally, the ratio of normal software to malicious software in packed files is often skewed, leading to a high likelihood of false positives.

As mentioned before, in the field of cybersecurity, detecting packed malware is a challenging task. However, there are several techniques and strategies that can be employed to identify and analyze packed malware. Some approaches for detecting packed malware will be introduced in the following.

Signature-based Detection involves creating signatures or patterns of known malware and comparing them with files or code samples. However, packed malware often uses encryption or obfuscation techniques, making it difficult to detect using traditional signature-based methods. This approach may result in a high false-negative rate.

Heuristic Analysis involves developing rules or algorithms that can identify potential malware based on suspicious behavior or characteristics. However, packed malware can evade heuristic analysis by employing sophisticated techniques that mimic legitimate software behavior. Consequently, false positives or false negatives may occur.

Sandbox Analysis involves running suspicious files or code samples in a controlled environment (sandbox) to observe their behavior. Such dynamic unpacking analysis method has some drawbacks, such as being slow and risky due to running the malware and potentially exposing the system to infection or damage. Additionally, some malware that uses anti-debugging or anti-vm techniques may be difficult or impossible to analyze through dynamic unpacking. Moreover, it may require manual intervention or analysis to identify the correct moment and location of the unpacking.

Machine Learning-based Approaches involve training models on large datasets of known malware and legitimate files to identify patterns and make predictions. However, the high dimensionality and complexity of packed malware can make feature extraction and model training challenging.

Behavior-based Detection focuses on monitoring the behavior of software to identify malicious activities. However, packed malware can exhibit benign behavior until it unpacks itself, making it difficult to detect using behavior-based methods.

In summary, the disadvantages of the foregoing security solutions for detecting packed malware include a high false-negative rate, evasion techniques employed by packed malware, difficulty in analyzing packed code, and the ability of packed malware to evade detection techniques. These challenges highlight the need for continuous research and development of detection methods to combat packed malware effectively.

The continuous increase of volume and complexity of malware, coupled with the introduction of various methods such as packers, introduces many challenges in detection and analysis. For instance, malware authors generate various malware instances from the same malware family. As a result, members of the same malware family are functionally identical, even though their binaries may greatly differ. As a result, researchers tend to leverage more on behavioral analysis instead of signature-based detection.

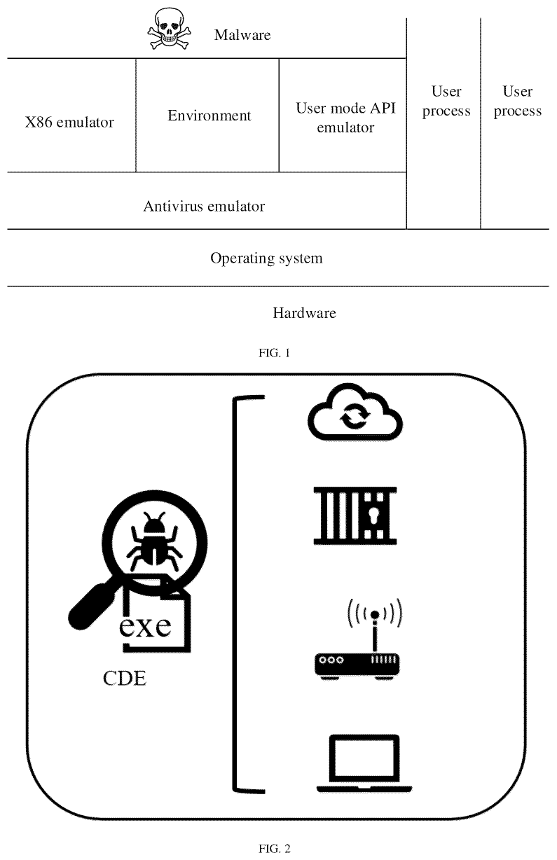

One way to determine the behavior is malware code emulation. FIG. 1 is a schematic illustration of a security architecture for a device to detect malware. As shown in FIG. 1, the architecture protects the system from malware by emulating at different levels, e.g., through an X86 emulator, a user mode application programming interface (API) emulator, an antivirus emulator, etc. The hardware provides a physical environment/component for the system. The operating system may provide basic system services and resource management. The antivirus emulator can emulate the behavior of the antivirus software to detect and prevent malware. The environment may include a file system, network connections, applications, and the like, which can provide the running environment for the user process. The user mode API emulator may be used for emulating API calls to prevent malware from directly accessing the system resources. X86 emulator may be used for emulating X86 running environment, providing a controlled environment for the malware and thereby preventing damage to the system. The user process may refer to applications running in the operating system.

Malware emulation is a method of emulating malware execution in a virtual (emulated) environment. In general, this approach is similar to that of malware execution in a sandbox, but emulation and full-featured sandboxing differ in details of design and application.

A sandbox, unlike an emulator, is a highly monitored and controlled environment that replicates a real user environment and execute the binary inside it to track its behavior. This method requires high computation power and poses compatibility limitations on the host system.

An emulator on the other hand emulates the execution of a binary in a host by replicating functions, system calls, and operating subsystems using far fewer resources than a sandbox. It has control over the emulated environment, which lets the emulator fast-forward time, witness future file behavior and prevent malware from evasion-by-time-delay.

With the increasing threats of malwares, researchers and antivirus companies need to be able to efficiently analyze malware to find its weaknesses and to properly combat them. Unfortunately, the majority of malware is packed. In order to analyze a packed malware sample or to generate a better signature, often time it is required to unpack the malware, hence the importance of a very good Unpacker appears.

In view of the above, in order to enhance file security and improve overall security capabilities, embodiments of the present disclosure bring an emulator-based method to effectively detect packed malware. The technical solution provided by the present disclosure can be applied to a content detection engine (CDE), which performs comprehensive scanning on different files.

FIG. 2 is a schematic illustration of the appliance or application scenarios of the malware detection solution according to one or more embodiments of the present disclosure. As shown in FIG. 2, CDE can be applied in endpoint detection and response (EDR), gateway, firewall and cloud, supporting end-to-end file protection for all above environments.

The proposed malware detection solution can find and extract the unpacking routine from a packed file and emulate the execution of the packed file to obtain an unpacked dump file, and then perform malware detection on the unpacked dump file. Since the dump file is obtained by emulating the execution of the packed file, hidden code or data that is revealed during dynamic unpacking would not be missed, and memory layout or imports of the original file can be preserved. The unpacked dump file can be obtained fast, for example, an emulator can unpack the packed file in millisecond-level. In addition, the proposed malware detection solution can use an AI-based detection method for malware detection on the unpacked dump file which can utilize the generalization power of AI. The malware detection solution proposed by the present disclosure can be more accurate and complete than pure static analysis detection, while being faster and easier than pure dynamic analysis detection methods. A packed file can be unpacked through an emulator fast, and malware detection, or AI-based malware detection with the accurate content of the unpacked file can be implemented instantly or nearly instantly.

The emulator in the embodiments of the present disclosure is a binary emulator designed to emulate binary files, such as Windows binaries. The initial goal of this emulator is to support unpacking to most common packers used by malwares, but it also can be extended to other purposes, such as Machine Learning malware detection based on emulation logs, shellcode emulation, and so on.

The emulator processes the packed file, then outputs a file with some information which is aligned with the original file. The output is called a dump file. The emulator can unpack the packed file fast. For example, the time for unpacking a 1M packed file would not exceed 300 ms.

For the data integrity after unpacking, the dump file will be as close as possible to the state of the original file before packing. If this state cannot be reached, the dump file is required to be executable. If execution requirement is not satisfied, it is necessary to ensure that the header (e.g., portable executable (PE) header for a Windows binary executable file), the code and the resource are restored.

The header of an executable file can include, e.g., information for file identification and classification, information for file loading, program metadata, information for dynamic linking, etc. The information for file identification and classification can identify file type, file format, machine architecture, etc. The information for file loading can include, e.g., information related to the starting address where the file is loaded in memory, information about file size, the entry point (EP) where execution begins after the file is loaded, etc. The program metadata can include, e.g., version information, generation time, etc. The information for dynamic linking can include, e.g., import/export information for dynamically linking to other libraries or modules at runtime.

In the technical solution proposed by the present disclosure, malware detection is performed on a dump file. A packed file will load the file exactly how the original file is loaded, while the emulator can unpack the packed file and load it into memory, then dump it out. So, the dump file, that is obtained with the emulator, and the original file should be the same, except their headers, such as PE headers for Windows binaries. Essentially, the header's purpose is to tell the operating system how to load the file in memory, and then start the execution at EP. When the file is loaded, the header is basically useless. The emulator can fix some of entries of the header to make the file as valid as possible, like setting the original entry point (OEP) and fixing imports etc. So, the anchor points between the original file and the dump file are their respective entry points, and it can be ensured that their entry point addresses are consistent, and the bytes around the entry points are also identical. This method locates the relevant information identical to the original file, which is essential for achieving plaintext AI-based malicious sample detection. Here, plaintext refers to reaching accurate information of the original files rather than packed samples or files.

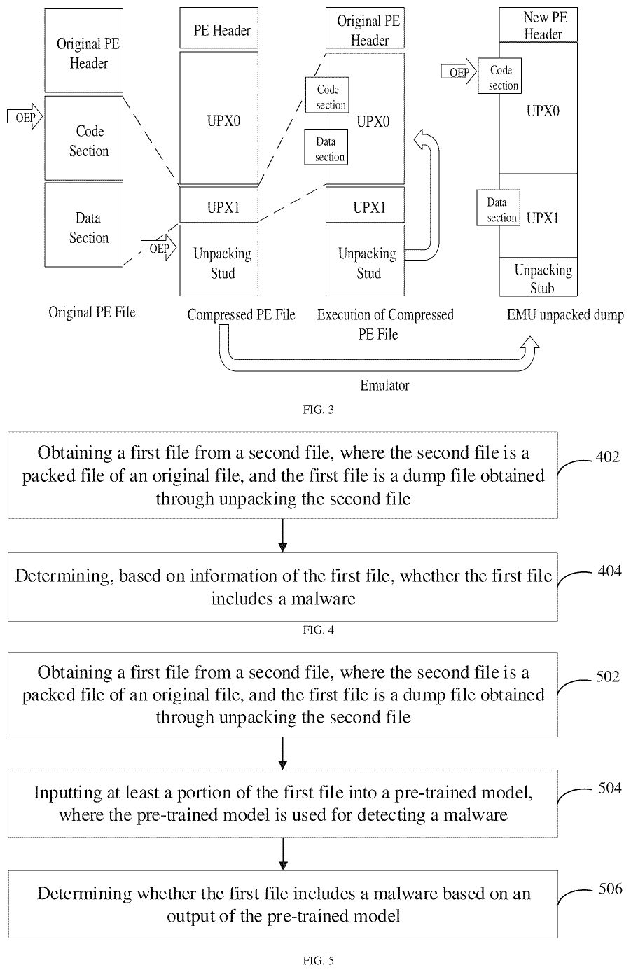

The processing of an executable file will be described by taking a PE file as an example. FIG. 3 is a schematic illustration of the processing of a PE file according to one or more embodiments of the present disclosure. As shown in FIG. 3, the original PE file can include a PE header, which is shown as Original PE header in the figure, as well as a code section and a data section. The entry point of the original PE file, which is shown as OEP, points to a position in the code section, and the execution of the original PE file begins at this position.

A packed file can be obtained by packing the original PE file. For example, a compressed PE file may be obtained through compressing the original PE file, e.g., by using Ultimate Packer for eXecutables (UPX) which is an executable file compressor. As shown in FIG. 3, the compressed PE file can include a PE header, a UPX0 section, a UPX1 section and an unpacking stub. The PE header is the file header of the compressed PE file. The UPX0 section does not contain actual content of the PE file, and will be filled with decompressed data when the compressed PE file is executed. The UPX1 section contains source data that needs to be decompressed. The code section and the data section of the PE file are compressed into the UPX1 section. Immediately following the source data block is the unpacking stub, which contains code responsible for decompressing the data in the UPX1 section to the UPX0 section during program execution and performing some necessary initialization operations. The OEP of the compressed PE file points to a position in the unpacking stub where the execution of the compressed PE file begins.

Further, if the compressed PE file is executed, as shown in FIG. 3, the execution starts from the unpacking stub, and the code section and the data section are decompressed into the UPX0 section, and the original PE header is restored.

When using an emulator to unpack the compressed PE file, the emulator can unpack the compressed PE file to obtain the dump file. For example, the emulator can emulate an operating environment by replicating functions, system calls, and operating subsystems, and emulate the execution of the compressed PE file in the emulated environment and then perform a memory dump to obtain the dump file. As an example, the emulator can unpack, in the emulated environment, the compressed PE file and load decompressed data into memory, then dump it out to get the unpacked dump file.

In an example, the dump file obtained by the emulator, e.g., shown as EMU unpacked dump in FIG. 3, has a new PE header, a UPX0 section which may contain the decompressed code section, a UPX1 section which may contain the decompressed data section, and the unpacking stub. The new PE header is different from the original PE header, but similar to the header of the compressed PE file. The OEP points to a position of the decompressed code section. The OEP of the unpacked dump file can be consistent with the OEP of the original file, and bytes around the OEP of the dump file can be identical to bytes around the OEP of the original file. The unpacked dump file can be the same as the original PE file except their PE headers.

Malware detection can be performed on the unpacked dump file. Since the dump file and the original file have consistent information, the detection accuracy can be ensured. When AI-based malware detection is employed, the dump file generated by the emulator can serve as the input of the AI model.

Some specific embodiments of the present disclosure will be elaborated in the following.

An embodiment of the present disclosure provides a malware detection method, and the method can be implemented by the CDE in a terminal or a server, or the like. As shown in FIG. 4, the method may include the following steps.

Step 402, obtaining a first file from a second file, where the second file is a packed file of an original file, and the first file is a dump file obtained through unpacking the second file.

Step 404, determining, based on information of the first file, whether the first file includes a malware.

This solution can be applied to detect malicious code in packed files through malware detection on dump files. The second file, which is a packed file, is software which is intended to be detected, while the first file refers to a dump file corresponding to the software. An original file refers to a file that has not been packed, for example, a file that has not been compressed or encrypted, while a packed file refers to a file that has been packed, for example, a file that has been compressed and/or encrypted, e.g., by using a packer. The dump file refers to a file that is obtained through processing the packed file, e.g., through emulating the execution of the packed file, and has information aligned with the original file. The first file (dump file) is obtained through unpacking the second file (a packed file), e.g., by an emulator.

After unpacking the packed file, that is, after the first file is obtained, analysis and detection can be performed based on information of the first file to determine whether the first file includes malware. That is, the malware detection is based on analysis and detection on a dump file. Further, the determination result of whether the dump file includes malware can indicate whether the packed file includes malware.

By performing malware detection on the dump file, the malware detection accuracy can be improved compared with static analysis detection, and the malware detection efficiency and safety can be improved compared with pure dynamic analysis detection (e.g., running the packed file). In this way, the proposed malware detection can be accurate and safe with competent speed.

In a possible implementation, when it is determined that the first file includes a malware, it can be determined that the second file includes malware; when it is determined that the first file does not include malware, it can be determined that the second file does not include malware. The determination result of whether the first file (i.e., the dump file) includes malware can indicate whether the second file (i.e., the packed file) includes malware. When the first file includes malware, it can be determined that the packed file (the second file) includes malware; when the first file does not include malware, it can be determined that the second file does not include malware. The malware detection for a packed file is associated with or depends on the malware detection for a dump file. The malware detection accuracy can be improved compared with static analysis detection, and the malware detection efficiency can be improved compared with pure dynamic analysis detection (e.g., running the packed file).

In a possible implementation, the determination of whether the first file includes malware can be implemented by an AI model. In this case, as shown in FIG. 5, the method may include the following steps.

Step 502, obtaining a first file from a second file, where the second file is a packed file of an original file, and the first file is a dump file obtained through unpacking the second file.

Step 504, inputting at least a portion of the first file into a pre-trained model, where the pre-trained model is used for detecting a malware; and

Step 506, determining whether the first file includes a malware based on an output of the pre-trained model.

Regarding step 502, reference may be made to the description of step 402, which will not be repeated here.

In step 504, a pre-trained model can be used for detecting malware in the first file. The model can be a CNN model which can handle sequence data and learn features regardless of position. It should be noted that, the model can also be an RNN model, an LSTM model, or a transformer model, or other sequence models, as long as the malware detection can be implemented, a specific model is not limited in the embodiments of the present disclosure. The model can be trained in advance with general samples, e.g., original file samples which are not packed, to learn features of known malware, and then used to detect malware in the first file, i.e., the dump file, since the dump file is very close to the state of the original file. The structure and training of the model will be described in detail below. By using the pre-trained model, the generalization power of AI model can be utilized to improve the malware detection performance.

The information inputted into the pre-trained model can be determined according to actual requirements.

In an implementation, the whole first file can be inputted into the pre-trained model for malware detection. This is easy and convenient to implement since it is not required to identify or locate some specific bytes to be inputted in to the model.

In another implementation, part of the first file can be inputted into the pre-trained model for malware detection. For example, bytes of the first file except the header can be inputted into the model for malware detection. Since the possibility that malicious code exists in the file header is very low, exclusion of the header would not affect the detection accuracy. For another example, bytes of the code section can be inputted into the pre-trained model for malware detection because if there is malicious code in the first file, it is highly likely to be present in this section. By inputting part of bytes of the first file into the model, the number of bytes to be processed by the model is reduced compared with inputting all bytes of the first file into the model, the processing speed can be increased.

In an implementation, the portion can include a first portion of the first file which has identical content (e.g., bytes) to a corresponding part (referred to as a second portion) of the original file, and at least the first portion of the first file can be inputted into the pre-trained model for malware detection. The first portion and the second portion may be some ranges of bytes in the first file and the second file respectively. For example, the first portion can be a range of bytes of the code section of the first file while the second portion can be a corresponding range of bytes of the code section of the original file. As mentioned above, the dump file can have information consistent/aligned with the original file, and the first portion of the first file can have identical content to its corresponding second portion of the original file. The malware detection is based on the content identical to the original file, hence, the malware detection accuracy can be ensured.

In an implementation, the first portion can include some bytes associated with an anchor point. For example, the anchor point can be the entry point of the first file, e.g., the OEP of the unpacked dump file as shown in FIG. 3. In this case, the information inputted into the model can include bytes (referred to as a first rang of bytes herein) around/nearby the entry point of the first file. As mentioned above, although the dump file and the original file have their respective entry points, their entry points are consistent and the bytes around the entry points are identical. Based on the entry point of the first file, the first range of bytes contained by the first portion can be located, and it can be ensured that the first range of bytes around the entry point of the first file has identical content to the same range of bytes around the entry point of the original file. When malware detection is performed on bytes around/nearby the entry point of the first file, detection accuracy can be ensured.

In a possible implementation, in order to locate the first portion of the first file, the entry point of the first file (dump file) can be obtained, where the entry point of the first file is consistent with the entry point of the original file. There are many ways to locate the entry point. For example, a pefile python lib may be used, and the device can read a file via pefile and name it as pe, and then can call “pe.get_offset_from_rva(pe.OPTIONAL_HEADER.AddressOfEntryPoint)” to locate the entry point.

In a possible implementation, the first range of bytes contained in the first portion may include some bytes before the entry point and/or some bytes after/starting from the entry point. In a possible implementation, the first range of bytes nearby the entry point includes a first number of bytes before the entry point and a second number of bytes after the entry point. The specific numbers of bytes before and after the entry points contained in the first portion can be determined according to actual requirement, which provides more flexibility for the malware detection.

Regarding the determination of the byte range around/nearby the entry point of the dump file (the first portion of the first file), byte range research can be conducted to locate the raw byte information near the entry point. An area under the curve (AUC) can be used as the assessment metric. Based on the result of the byte range research, the range of 128 bytes before the entry point and 512 bytes after the entry point has the highest AUC score, which means that, using 128 bytes before and 512 bytes after the entry point of the dump file for malware detection would have the best performance. By utilizing byte data less than 1 KB, the AI model (e.g., a 1D CNN model) can make relatively accurate predictions.

In an implementation, the information inputted into the model can be narrowed down according to an anchor point. For example, only the first portion, i.e., the first range of bytes nearby the entry point of the first file, is inputted into the model for malware detection. Since the first portion contains bytes of the code section nearby the entry point where malicious code is highly likely present if any, the detection accuracy can be ensured. Meanwhile, the processing speed can be improved due to fewer bytes to be processed.

In a possible implementation, in order to improve the model accuracy, the information of the first file may be scaled, and then the scaled values are input into the pre-trained model for detection. By scaling the information of the first file, the input information can be standardized to a specified range, which can improve the accuracy of the model since the model can achieve better performance at similar scales.

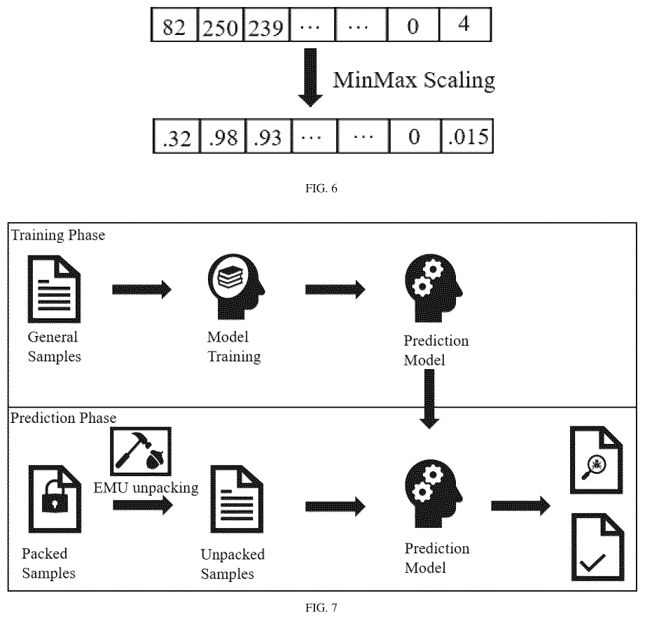

In an example, the bytes of the first portion can be extracted as a sequence of integer numbers. For example, each byte may be converted to an integer number within a range from 0 to 255, and the extracted sequence can be a list of integer numbers with a range from 0 to 255, which is converted from raw byte list (i.e., raw bytes of the first portion). Then all elements in the extracted list are scaled via min-max scaler, which ensures all scaled values are in the range from 0 to 1. The scaled sequence which includes the scaled values, will be the input for the model. FIG. 6 is a schematic illustration of scaling the extracted sequence according to one or more embodiments of the present disclosure.

Next, the model and the training of the model will be described.

In a possible implementation, a model, such as a CNN model, an RNN model, a LSTM model, a transformer model, can be trained with training samples to obtain the pre-trained model for malware detection. These models can handle sequence data and learn features from sequence data. After training, the trained model can detect malware in input sequences. Since the dump file is very close to the state of the original file, the trained model can be used for malware detection on dump files.

The training data (samples) will be general samples (which means there is no need to unpack the samples), i.e., original file samples that are not packed, but the model, after being trained, can still predict malware in packed files (through predicting malware in dump files), because the extracted byte sequences from the dump files are identical to the ones from the original files. This is different from the traditional way to use AI to detect unpacked files. Generally, to detect unpacked files via AI, a huge number of unpacked samples is required due to many different packers and their different versions. However, this method does not require a large amount of data preparation, since the model is trained on general samples.

The training samples can include samples containing malware or malicious code, and can also include samples not containing malware or malicious code. Each training sample can be a file that has not been packed (neither compressed nor encrypted), or a portion of a file that has not been packed. A sequence model can be trained with the training samples to obtain the pre-trained model. As described above, for malware detection, a sequence of integer numbers can be obtained from bytes of the dump file, and then scaled and input into the trained model. Correspondingly, during training, a sequence of integer numbers can be obtained from each training sample, and then scaled and input to the model which is being trained. By scaling, the sequences of training samples can be standardized to a specified range, which can improve the convergence of the model.

When the training samples include samples of various types of malware, the trained model may not only predict whether there is malware in the dump file, but also identify a specific type of the malware if malware is detected.

The model is trained with general samples, other than packed files or unpacked files obtained through unpacking packed files. The model trained with general samples can be used for malware detection on dump files since dump files have information consistent/aligned with original files. Training a model with general samples would be easy to maintain and implement. In addition, there is no need to prepare a large amount of unpacked data for various types and versions of packers which is necessary for model training of traditional AI-based malware detection.

FIG. 7 is a schematic illustration of the malware detection process according to one or more embodiments of the present disclosure. As shown in FIG. 7, the malware detection process may include a training phase and a prediction phase. In the training phase, model training may be implemented based on general samples to obtain the prediction model (a specific example of the aforementioned pre-trained model, or AI model) for predicting whether a dump file includes malware. In the prediction phase, the emulator unpacks the packed samples (a specific example of the second file) to obtain the unpacked dump file samples (a specific example of the first file), and then the unpacked dump file samples are input into the prediction model. The prediction model may work and output a determination result of whether malware is detected.

The technical solution provided by the present disclosure utilizes the emulator (EMU)+AI method to detect the packed malware. EMU refers to emulator, which can have millisecond-level unpacking ability and can convert packed files (e.g., the aforementioned second file) into unpacked files (e.g., the aforementioned first file/dump file). The unpacked file will contain the code and data sections of the original file, and the entry point address and bytes nearby the entry point can be guaranteed to be consistent. The unpacked file will be predicted by an AI model to output whether it is malicious or not.

FIG. 8 is another schematic illustration of the malware detection process according to one or more embodiments of the present disclosure, where the model is a 1D CNN model. As shown in FIG. 8, the emulator unpacks the packed sample (a specific example of the second file) to obtain the unpacked sample (a specific example of the first file). Then, feature extraction can be performed on the unpacked sample based on the raw bytes at the entry point. As mentioned before, the extracted sequence may be a list of integer numbers with a range from 0 to 255, and min-max scaling may be performed on the extracted sequence to obtain the scaled sequence with a range from 0 to 1.

Next, the scaled sequence can be input into the pre-trained model. Here, the AI model can be a 1D CNN model consisting of two layers of 1D CNN followed by multiple fully connected layers, supplemented by techniques such as BatchNorm and dropout. As shown in FIG. 8, the 1D CNN model may include a 1D convolution filter layer, a 1D convolution feature mapping layer, a 1D global max pooling layer, multiple fully-connected layers and a decision layer which can be a sigmoid layer. Finally, the 1D CNN model may output a determination result of whether malware is detected.

The first 1D CNN layer may have 128 channels and the kernel size may be 8, while the second 1D CNN layer may have 32 channels and the kernel size may be 4. Then, a max pooling layer is added with length=3 and stride=1. The followed fully connected layers have 128 and 32 neurons, and the dropout rates are 0.5 and 0.3 respectively to prevent overfitting. In addition, BatchNorm is applied to all fully connected layers, which can help in stabilizing and accelerating the training process. Finally, a sigmoid layer is to output a probability value, e.g., between 0 and 1. This probability represents the likelihood that the input include malware. This architecture is suitable for detecting malware by extracting relevant features from sequential data (e.g., integer number sequences converted from raw bytes) using convolutional layers, reducing dimensionality with pooling, and making a final decision with the fully connected layers and the sigmoid layer. The use of dropout and batch normalization helps in preventing overfitting and improving the model's generalization to unseen data. It should be noted that, the aforementioned specific values for the 1D CNN model are only illustrative but not restrictive, other specific values can be set according to actual requirements.

The training data for the AI model is general data (the aforementioned general samples), while the inference data is EMU unpacked dump data. This is achievable because the entry point is used as an anchor to accurately locate the information consistent with the original file, so there is no need to prepare a large amount of unpacked data for training. The advantage of the CNN model, e.g., 1D CNN model, is that it can handle sequence data and learn convolutional kernel features that are not affected by position. This is very important because the structure and position information of PE files can be either tampered by malicious software writers, or the emulator unpacking process. In some cases, the positions of some code may differ between the dump file and original file due to packing/unpacking. In some cases, malicious code in the dump file may be in a different position than that in the training sample. The malware can still be detected in such cases as long as that part of code is input into the model, since CNN model can learn features that are not affected by position and detect malware regardless of position. Moreover, the model training is operated on general data, but the trained model can be used to predict packed files. There is no need to prepare a large amount of unpacking data, it is easy to maintain, and easy to implement.

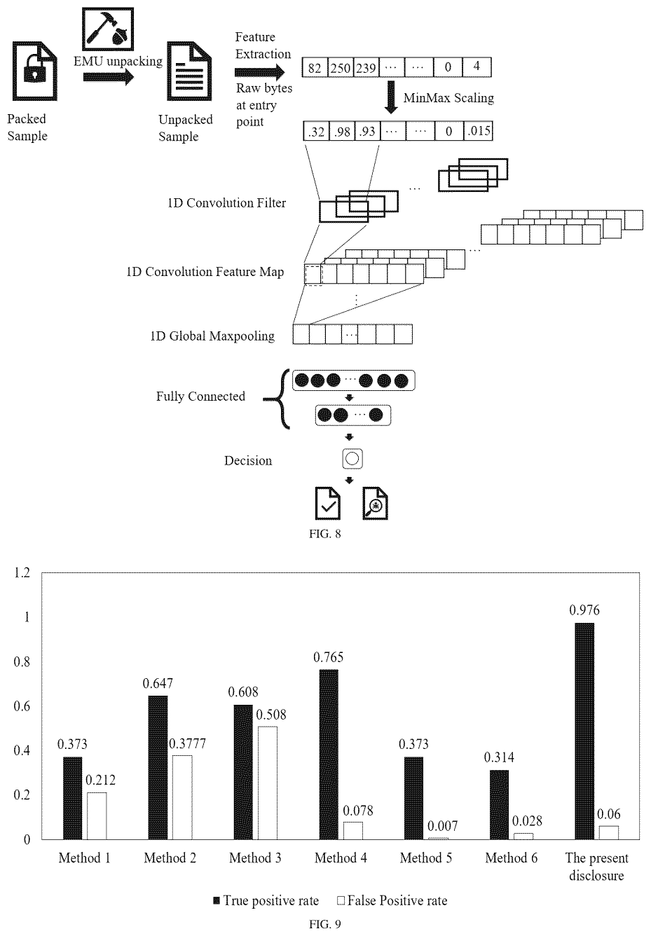

FIG. 9 is a schematic illustration of true positive rate and false positive rate for different malware detection methods and the malware detection method of the present disclosure. As shown in FIG. 9, for the same packed sample dataset, the malware detection solution provided by the present disclosure outperforms over other solutions, achieving high TPR (True Positive Rate) and low FPR (False Positive Rate).

In view of the foregoing, for the dump file, anchor points are used to obtain consistent information with the original file, thus plaintext AI can be implemented, and this will form a dimensionality reduction strike against the encrypted AI and meta AI model. Based on the millisecond-level unpacking ability of the emulator, it can achieve quasi-static detection of plaintext AI. It is faster than dynamic analysis and more accurate than static analysis. The 1D CNN model processes byte data. Regardless of the position, it can obtain the convolutional kernel features to detect malware, thereby solving the problem of the non-fixed position/location of data and code sections in dump files obtained with the emulator.

Given that the 1D CNN model can obtain convolutional kernel features regardless of the positions, in addition to extracting features of the bytes nearby the entry point, there may be another implementation manner. It does not require anchor point (finding entry points), that is, convolutional learning may be performed on all bytes of the file except the PE header. The emulator can reproduce the information of data sections and code sections, although the positions are not fixed, but using the 1DCNN model, effective features can still be learned.

As mentioned above, the pre-trained model may be a CNN model, an RNN model, an LSTM model, or a transformer model. Besides the CNN model, such as the aforementioned 1D CNN model, other sequence models can also be adopted as the implementation manner of the aforementioned pre-trained AI model, including but not limited to RNN models, LSTM models, Transformer models, etc. FIG. 10 is still another schematic illustration of the malware detection process according to one or more embodiments of the present disclosure. Regarding the training phase, the prediction phase and the inference process, reference may be made to the foregoing description of FIGS. 7 and 8, which will not be repeated here. CNN models can extract features regardless of position, and they are good at extracting local features and structure features, highly tolerant to noise and variations, efficient in processing data and suitable for large datasets. RNN models can handle sequences by considering previous states at each time step and capture the sequential information and understand the behavior logic of malware, and their computational cost increases significantly with the length of the sequence, which may limit their application in malware detection on long sequence data. LSTM models have gating mechanisms and can capture long-term dependencies in the input sequences and are good for modeling complex behavior patterns with high accuracy, and they generally have complex structure with more parameters and computations, requiring more training data and resources. Transformer models can simultaneously focus on different parts of malware feature representations, they have no loop structure and can be highly parallelized, which can significantly improve the training and detection speed, and they require a large amount of high-quality data for training due to a large number of parameters. A specific type of model can be selected according to actual requirements.

In a possible implementation, signature-based detection can be used to determine whether the first file includes malware. In this case, a signature of the first file may be generated after the first file is obtained, and based on signature, whether the first file includes malware can be determined. The signature can be generated based on part of the first file, which may be called a third portion of the first file. Similar to the AI-based method where some bytes around/nearby the entry point of the first file are used for malware detection, the third portion for generating the signature can also include some bytes around/nearby the entry point of the first file, which may be called a second range of bytes nearby the entry point of the first file. The third portion can include the same bytes as the first portion, or include different bytes from the first portion.

In possible implementations, the signature of the first file can be generated based on statistical information of the third portion of the first file or hashing of the third portion of the first file. The statistical information or hashing of the bytes near the entry points of the dump files can be used for malware detection instead of AI models.

After the signature of the first file is generated, it can be compared with signatures of known malwares to determine whether the first file includes malware. For example, if the signature of the first file matches one or more signatures of known malware, it can be determined that the first file includes malware; and if the signature of the first file does not match any one of the signatures of known malware, it can be determined that the first file does not include malware.

In this way, the malware detection for the dump file can be easily implemented based on signature, thereby providing a simple but effective way for the malware detection. Signature-based malware detection on dump files can be employed, e.g., when no trained model is available, for example, when the model has not been well-trained, e.g., due to insufficient training data.

The above describes the malware detection method proposed by the present disclosure, where detection is conducted on dump files to determine whether the dump file includes malware, and the determination result can indicate whether the packed file include malware. FIG. 3 takes decompressing of a compressed PE file as an example to describe the operation of the emulator. It should be noted that, the method proposed by the present disclosure can also be used for other types of executable files, and the method can also be used for analyzing encrypted traffic. When applied for analyzing encrypted files, if fast decryption of encrypted files can be achieved, malware detection can also have competent speed.

Next, embodiments of products related to the embodiments of the present disclosure will be described.

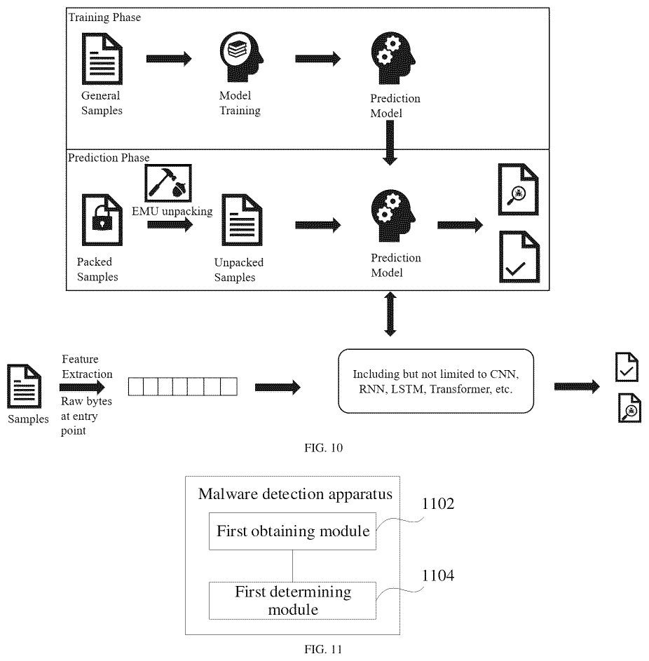

FIG. 11 illustrates an example malware detection apparatus 1100 according to an implementation of the present disclosure. The malware detection apparatus 1100 includes a first obtaining module 1102 and a first determining module 1104. The first obtaining module 1102 is configured to obtain a first file from a second file, where the second file is a packed file of an original file, and the first file is a dump file obtained through unpacking the second file. The first determining module 1104 is configured to determine, based on information of the first file, whether the first file includes a malware.

In a possible implementation, the apparatus further includes a second determining module, where the second determining module is configured to determine that the second file includes a malware when it is determined that the first file includes a malware; and determine that the second file does not include a malware when it is determined that the first file does not include a malware.

In a possible implementation, the first determining module is specifically configured to: input the information of the first file into a pre-trained model, where the pre-trained model is used for detecting a malware, and the information of the first file includes at least a portion of the first file; and determine whether the first file includes a malware based on an output of the pre-trained model.

In a possible implementation, the portion of the first file includes a first portion of the first file, and content of the first portion of the first file is identical to content of a second portion of the original file.

In a possible implementation, the apparatus further includes a second obtaining module, where the second obtaining module is configured to obtain an entry point of the first file, where the entry point of the first file is consistent with an entry point of the original file.

In a possible implementation, the first portion of the first file includes a first range of bytes nearby the entry point of the first file.

In a possible implementation, the first range of bytes nearby the entry point includes a first number of bytes before the entry point and a second number of bytes after the entry point.

In a possible implementation, the first determining module is specifically configured to input the first portion of the first file into the pre-trained model.

In a possible implementation, the first determining module is specifically configured to: obtain integer numbers based on the information of the first file, scale the integer numbers to obtain scaled values, and input the scaled values into the pre-trained model.

In a possible implementation, the apparatus further includes a third obtaining module and a training module. The third obtaining module is configured to obtain training samples, where each of the training samples is a file that has not been packed or encrypted, or a portion of a file that has not been packed or encrypted, and one or more samples of the training samples include a malware. The training module is configured to train a model with the training samples to obtain the pre-trained model.

In a possible implementation, the pre-trained model includes at least one of: a convolutional neural network (CNN) model, a recursive neural network (RNN) model, a long short-term memory (LSTM) model, or a transformer model.

In a possible implementation, the first determining module is specifically configured to: generate a signature of the first file based on a third portion of the first file, where the information of the first file includes the third portion of the first file, and the third portion of the first file includes a second range of bytes nearby an entry point of the first file; and determine whether the first file includes a malware based on a comparison of the signature of the first file and signatures of malwares.

In a possible implementation, the signature of the first file is generated based on statistical information of the third portion of the first file or hashing of the third portion of the first file.

It should be noted that, the first obtaining module, the second obtaining module, and the third obtaining module are only illustrative for their functions, in practice, the functions of the first obtaining module, the second obtaining module, and the third obtaining module may be implemented by one obtaining module, which is not limited here. It should also be noted that, the first determining module and the second determining module are only illustrative for their functions, in practice, the functions of the first determining module and the second determining module may be implemented by one determining module, which is not limited here. It should also be noted that, some of the aforementioned modules may be implemented by one module.

The malware detection apparatus may be applied to the terminal/server as described in the above method embodiments or may be the terminal/server as described in the above method embodiments. It should be understood by a person skilled in the art that, the relevant description of the above units in the embodiments of the present disclosure may be understood with reference to the relevant description of the malware detection method in the embodiments of the present disclosure.

FIG. 12 is a schematic structural diagram of a computing device according to one or more embodiments of the present disclosure. As shown in FIG. 12, the computing device 1200 includes a processor 1202, an interface 1204 for communicating with other devices, a memory 1206, and a bus 1208. The processor 1202, the interface 1204, and the memory 1206 are in communication with each other via the bus 1208. The memory 1206 may be stored with computer execution instructions, and the processor 1202 executes computer execution instructions stored in the memory 1206 to enable the computing device to execute any of the above methods. The computing device 1200 can be a server or a terminal device. The number of processors and memories in the computing device 1200 is not limited in the embodiments of the present disclosure.

The bus 1208 can be a peripheral component interconnect (PCI) bus or an extended industry standard architecture (EISA) bus, etc. Buses can be categorized as address buses, data buses, control buses, etc. For ease of representation, only one line is used in FIG. 12, but it does not mean that there is only one bus or one type of bus. The bus 1208 may include pathways for transferring information between various components of the computing device 1200 (e.g., the memory 1206, the processor 1202, or the interface 1204).

The processor 1202 can include any one or more of a central processing unit (CPU), a graphics processing unit (GPU), a microprocessor (MP), or a digital signal processor (DSP) processor.

The memory 1206 can include volatile memory, such as random access memory (RAM). The processor 1202 can also include non-volatile memory, such as read-only memory (ROM), flash memory, a mechanical hard disk (HDD), or a solid state drive (SSD).

An executable program code is stored in the memory 1206, and the processor 1202 executes the executable program code to implement the functions of the aforementioned obtaining modules, determining modules, and the training module, respectively, so as to implement the method described in the above embodiments. That is, the memory 1206 has instructions on it for executing the method described in the above embodiments.

The structure of the computing device 1200 enumerated above is only an exemplary illustration, and the present disclosure is not limited thereto. The computing device 1200 of embodiments of the present application includes a variety of hardware found in computer systems in the prior art, e.g., the computing device 1200 also includes memory other than the memory 1206, such as, for example, a disk memory, and the like. It should be understood by those skilled in the art that the computing device 1200 can also include other devices necessary to achieve proper operation. In addition, depending on the specific needs, one of skill in the art should understand that the above-described computing device 1200 may also include other hardware devices for realizing other additional functions. In addition, one of skill in the art should understand that the above-described computing device 1200 may also include only the devices necessary to realize the embodiments of the present disclosure, and need not include all of the devices shown in FIG. 12.

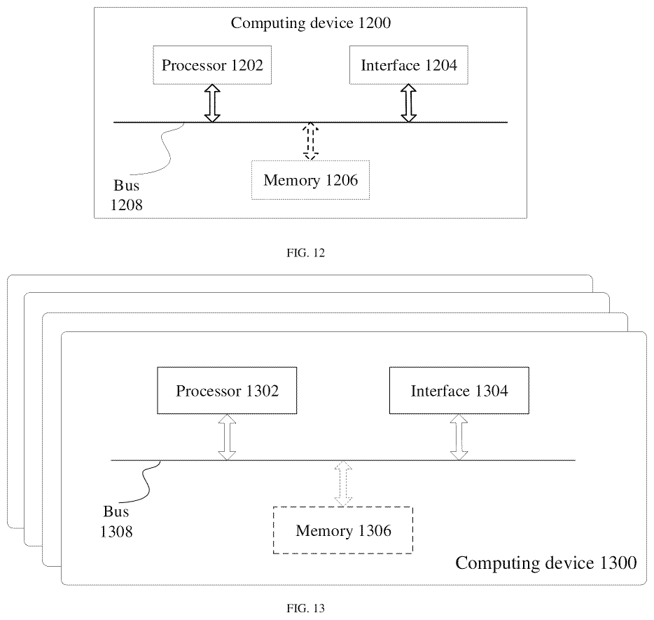

FIG. 13 is a schematic diagram of an architecture of a computing device cluster according to one or more embodiments of the present disclosure. The computing device cluster includes at least one computing device. The computing device can be a server, such as a central server, an edge server, or a local server in a local data center. In some embodiments, the computing device can also be a terminal device such as a desktop computer, a laptop computer, or a smartphone.

As shown in FIG. 13, the cluster of computing devices described includes at least one computing device 1300. Each computer device 1300 in the cluster of computing devices may include a processor 1302, an interface 1304 for communicating with other devices, a memory 1306, and a bus 1308. Regarding the explanation for the processor 1302, the interface 1304, the memory 1306 and the bus 1308, reference may be made to the relevant description of FIG. 12, which will not be repeated here. The memory 1306 in one or more of the computing devices 1300 in the cluster of computing devices can hold the same instructions for performing the method described in the above embodiments.

In some possible implementations, some of the instructions for performing the method described in the above embodiments can also be separately held in the memory 1306 of the one or more computing devices 1300 in the cluster of computing devices. In other words, a combination of the one or more computing devices 1300 can jointly execute instructions for performing the method described in the above embodiments.

It is noted that the memories 1306 in the different computing devices 1300 in the cluster of computing devices can store different instructions for performing some of the functions of the computing devices 1300, respectively. That is, the instructions stored in the memories 1306 in the different computing devices 1300 can realize the functions of one or more of the obtaining modules, the determining modules, and the training module.

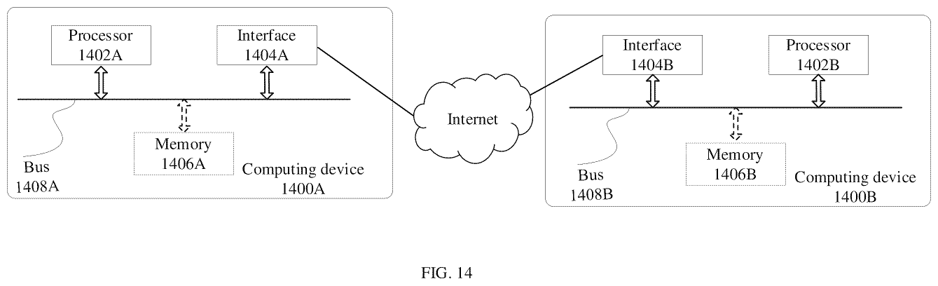

In some possible implementations, one or more computing devices in a cluster of computing devices can be connected via a network. Among other things, the network can be a wide area network or a local area network, etc. FIG. 14 illustrates one possible implementation. FIG. 14 is a schematic diagram of a connection between computing devices 1400A and 1400B over a network according to one or more embodiments of the present disclosure. The two computing devices 1400A and 1400B are connected to each other via a network. As shown in FIG. 14, the computing device 1400A includes a processor 1402A, an interface 1404A for communicating with other devices, a memory 1406A, and a bus 1408A; while the computing device 1400B includes a processor 1402B, an interface 1404B for communicating with other devices, a memory 1406B, and a bus 1408B. Regarding the explanation for the processor 1402A/1402B, the interface 1404A/1404B, the memory 1406A/1406B and the bus 1408A/1408B, reference may be made to the relevant description of FIG. 12, which will not be repeated here. Specifically, the connection to said network is made through a communication interface in each computing device. In this class of possible implementations, the memory 1406A in the computing device 1400A holds instructions for performing the functions of the first obtaining module, the first determining module, the second determining module and the second obtaining module. At the same time, the memory 1406B in the computing device 1400B holds instructions for performing the functions of the third obtaining module and the training module.

The connection between the clusters of computing devices shown in FIG. 14 can be such that, considering that the method provided in the present disclosure requires processing a large number of data, it is contemplated that the functions realized by the training module be performed by the computing device 1400B.

The functions of computing device 1400A illustrated in FIG. 14 can also be accomplished by multiple computing devices. Similarly, the functions of computing device 1400B can be accomplished by multiple computing devices.

In some aspects of the present disclosure, there is provided a malware detection apparatus including processing circuitry for executing any of the above methods. It should be understood that the apparatus can execute the steps in the above method embodiments, which will not be repeated here.

In some aspects of the present disclosure, there is provided a computing device cluster including at least one computing device, and the computing device includes a processor and a memory coupled with the processor. The memory is storing instructions which, when executed by the processor, cause the computing device cluster to perform any of the above methods.

In some aspects of the present disclosure, there is provided a chip, including an input/output (I/O) interface and a processor, where the processor is configured to call and run computer execution instructions stored in a memory, to enable a device installing with the chip to execute any of the above methods.

In some aspects of the present disclosure, there is provided a computer-readable medium storing computer execution instructions which, when executed by a processor, cause the processor to execute any of the above methods.

In some aspects of the present disclosure, there is provided a computer program product including computer execution instructions which, when executed by a processor, cause the processor to execute any of the above methods.

In some aspects of the present disclosure, there is provided a computer program including computer execution instructions which, when executed by a processor, cause the processor to execute any of the above methods.

The embodiments may further be described using the following clauses.

Clause 1: A malware detection method, including:
obtaining a first file from a second file, where the second file is a packed file of an original file, and the first file is a dump file obtained through unpacking the second file; and
determining, based on information of the first file, whether the first file includes a malware.

Clause 2. The method of clause 1, further including:
determining that the second file includes a malware when it is determined that the first file includes a malware; and
determining that the second file does not include a malware when it is determined that the first file does not include a malware.

Clause 3. The method of clause 1 or 2, where the determining, based on information of the first file, whether the first file includes a malware includes:
inputting the information of the first file into a pre-trained model, where the pre-trained model is used for detecting a malware, and the information of the first file includes at least a portion of the first file; and
determining whether the first file includes a malware based on an output of the pre-trained model.

Clause 4. The method of clause 3, where the portion of the first file includes a first portion of the first file, and content of the first portion of the first file is identical to content of a second portion of the original file.

Clause 5. The method of clause 4, where the first portion of the first file includes a first range of bytes nearby an entry point of the first file, and the method further includes obtaining the entry point of the first file, where the entry point of the first file is consistent with an entry point of the original file.

Clause 6. The method of clause 5, where the first range of bytes nearby the entry point includes a first number of bytes before the entry point and a second number of bytes after the entry point.

Clause 7. The method of any one of clauses 4 to 6, where the inputting the information of the first file into a pre-trained model includes: inputting the first portion of the first file into the pre-trained model.

Clause 8. The method of any one of clauses 3 to 7, where the inputting the information of the first file into a pre-trained model includes:
obtaining integer numbers based on the information of the first file;
scaling the integer numbers to obtain scaled values; and
inputting the scaled values into the pre-trained model.

Clause 9. The method of any one of clauses 3 to 8, further including:
obtaining training samples, where each of the training samples is a file that has not been packed or encrypted, or a portion of a file that has not been packed or encrypted, and one or more samples of the training samples include a malware; and
training a model with the training samples to obtain the pre-trained model.

Clause 10. The method of any one of clauses 3 to 8, where the pre-trained model includes at least one of: a convolutional neural network (CNN) model, a recursive neural network (RNN) model, a long short-term memory (LSTM) model, or a transformer model.

Clause 11. The method of clause 1, where the determining, based on the information of the first file, whether the first file include a malware includes:
generating a signature of the first file based on a third portion of the first file, where the information of the first file includes the third portion of the first file, and the third portion of the first file includes a second range of bytes nearby an entry point of the first file; and
determining whether the first file includes a malware based on a comparison of the signature of the first file and signatures of malwares.

Clause 12. The method of clause 11, where the signature of the first file is generated based on statistical information of the third portion of the first file or hashing of the third portion of the first file.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

1. A malware detection method, comprising:
obtaining a first file from a second file, wherein the second file is a packed file of an original file, and the first file is a dump file obtained through unpacking the second file; and
determining, based on information of the first file, whether the first file comprises a malware.

2. The method of claim 1, further comprising:
determining that the second file comprises a malware when it is determined that the first file comprises a malware; and
determining that the second file does not comprise a malware when it is determined that the first file does not comprise a malware.

3. The method of claim 1, wherein the determining, based on the information of the first file, whether the first file comprises a malware comprises:
inputting the information of the first file into a pre-trained model, wherein the pre-trained model is used for detecting a malware, and the information of the first file comprises at least a portion of the first file; and
determining whether the first file comprises a malware based on an output of the pre-trained model.

4. The method of claim 3, wherein the portion of the first file comprises a first portion of the first file, and content of the first portion of the first file is identical to content of a second portion of the original file.

5. The method of claim 4, wherein the first portion of the first file comprises a first range of bytes nearby an entry point of the first file, and the method further comprises obtaining the entry point of the first file, wherein the entry point of the first file is consistent with an entry point of the original file.

6. The method of claim 5, wherein the first range of bytes nearby the entry point comprises a first number of bytes before the entry point and a second number of bytes after the entry point.

7. The method of claim 4, wherein the inputting the information of the first file into the pre-trained model comprises inputting the first portion of the first file into the pre-trained model.

8. The method of claim 3, wherein the inputting the information of the first file into the pre-trained model comprises:
obtaining integer numbers based on the information of the first file;
scaling the integer numbers to obtain scaled values; and
inputting the scaled values into the pre-trained model.

9. The method of claim 3, further comprising:
obtaining training samples, wherein each of the training samples is a file that has not been packed or encrypted, or a portion of a file that has not been packed or encrypted, and one or more samples of the training samples comprise a malware; and
training a model with the training samples to obtain the pre-trained model.

10. The method of claim 3, wherein the pre-trained model comprises at least one of: a convolutional neural network (CNN) model, a recursive neural network (RNN) model, a long short-term memory (LSTM) model, or a transformer model.

11. The method of claim 1, wherein the determining, based on the information of the first file, whether the first file comprise a malware comprises:
generating a signature of the first file based on a third portion of the first file, wherein the information of the first file comprises the third portion of the first file, and the third portion of the first file comprises a second range of bytes nearby an entry point of the first file; and
determining whether the first file comprises a malware based on a comparison of the signature of the first file and signatures of malwares.

12. The method of claim 11, wherein the signature of the first file is generated based on statistical information of the third portion of the first file or hashing of the third portion of the first file.

13. A malware detection apparatus, comprising:
one or more processor; and
one or more memories storing instructions which, when executed by the one or more processors, cause the apparatus to perform steps of:
obtaining a first file from a second file, wherein the second file is a packed file of an original file, and the first file is a dump file obtained through unpacking the second file; and
determining, based on information of the first file, whether the first file comprises a malware.

14. The apparatus of claim 13, wherein the apparatus is further caused to perform steps of:
determining that the second file comprises a malware when it is determined that the first file comprises a malware; and
determining that the second file does not comprise a malware when it is determined that the first file does not comprise a malware.

15. The apparatus of claim 13, wherein the determining, based on information of the first file, whether the first file comprises a malware comprises:
inputting the information of the first file into a pre-trained model, wherein the pre-trained model is used for detecting a malware, and the information of the first file comprises at least a portion of the first file; and
determining whether the first file comprises a malware based on an output of the pre-trained model.

16. The apparatus of claim 15, wherein the portion of the first file comprises a first portion of the first file, and content of the first portion of the first file is identical to content of a second portion of the original file.

17. The apparatus of claim 16, wherein the first portion of the first file comprises a first range of bytes nearby an entry point of the first file, and the apparatus is further caused to obtain the entry point of the first file, wherein the entry point of the first file is consistent with an entry point of the original file.

18. The apparatus of claim 16, wherein the first range of bytes nearby the entry point comprises a first number of bytes before the entry point and a second number of bytes after the entry point.

19. The apparatus of claim 15, wherein the inputting the information of the first file into the pre-trained model comprises:
obtaining integer numbers based on the information of the first file;
scaling the integer numbers to obtain scaled values; and
inputting the scaled values into the pre-trained model.

20. A non-transitory computer-readable storage medium, wherein the medium is configured to store instructions which, when executed by a computer, cause the computer to perform steps of:
obtaining a first file from a second file, wherein the second file is a packed file of an original file, and the first file is a dump file obtained through unpacking the second file; and
determining, based on information of the first file, whether the first file comprises a malware.
